(19) United States
(12) Patent Application Publication
(10) Pub. No.: US 2025/0190691 A1
(43) Pub. Date: Jun. 12, 2025

(54) MACHINE LEARNING MODELING TO PREDICT CONTENT TO EXTRACT FROM A DOCUMENT

(71) Applicant: Bank of Montreal, Toronto (CA)

(72) Inventors: Yanming Mai, Toronto (CA); Bo Wan, Toronto (CA); Yongbo Tang, Toronto (CA); Bo Wu, Toronto (CA); Jon WANG, Toronto (CA); Ching Leong WAN, Toronto (CA); Graeme Whittington, Toronto (CA)

(73) Assignee: Bank of Montreal, Toronto (CA)

(21) Appl. No.: 18/970,843

(22) Filed: Dec. 5, 2024

Related U.S. Application Data
(60) Provisional application No. 63/607,496, filed on Dec. 7, 2023.

(51) Int. Cl. G06F 40/174; G06V 10/774; G06V 30/413

(52) U.S. Cl. CPC G06F 40/174; G06V 10/774; G06V 30/413

(57) ABSTRACT

A server may automatically determine a classification for document text of an electronic document and display a graphical indication of the classification of document text in a first graphical region of a first graphical user interface. In response to the server receiving an approval of the classification, the server may generate a label for the document text based on the classification and train a machine learning (ML) model using the label and the electronic document. Furthermore, the server may execute the trained ML model for a second electronic document. For at least one field of a form on a webpage, the server may automatically complete a widget embedded in the web page, using the trained ML model display a second graphical indication of text in the second electronic document providing data for the at least one field.

### CROSS-REFERENCE TO RELATED APPLICATIONS

This application claims priority to U.S. Provisional Application No. 63/607,496, filed Dec. 7, 2023, which is incorporated herein by reference in its entirety for all purposes.

### TECHNICAL FIELD

This application relates generally to using artificial intelligence models to extract content from a document.

### BACKGROUND

As the processing power of computers allows for greater computer functionality and the Internet technology era allows for interconnectivity between computing system, many organizations utilize sophisticated computing systems to support data exchange amongst entities. For instance, a corporation use sophisticated computing systems to send documents to another corporation. Conventional computer-implemented methods can extract content from the document which may be deemed as important or necessary to capture.

Conventional software solutions and computer-implemented methods suffer from a technical shortcoming. For instance, even using state of the art extraction techniques does not provide the most accurate extracted content from a document because conventional software solutions typically require a specific format for the document and are unable to leverage all content available. Furthermore, conventional software solutions cannot adjust themselves to account for distorted or blurred images of documents. In order to address the above-described technical shortcoming, organizations are forced to analyze documents individually, which requires high computational capacity and processing time.

### SUMMARY

Systems and methods described herein attempt to address the deficiencies of the conventional solutions. The systems and methods may display a graphical indication of text in an electronic document providing data for at least one field of a form. The systems and methods may display a list of widgets corresponding to the at least one field of the form, where the list of widgets includes predicted content from the trained machine learning (ML) model and a confidence score.

Embodiments disclosed herein provide solutions to the aforementioned problems and provide other solutions as well. A server may automatically determine a classification for document text of an electronic document and display a graphical indication of the classification of document text in a first graphical region of a first graphical user interface. In response to the server receiving an approval of the classification, the server may generate a label for the document text based on the classification and train an ML model using the label and the electronic document. Furthermore, the server may execute the trained ML model for a second electronic document. For at least one field of a form on a webpage, the server may automatically complete a widget embedded in the web page, the at least one field using the trained ML model display a second graphical indication of text in the second electronic document providing data for the at least one field.

In an embodiment, a computer-implemented method for displaying a graphical indication of text in an electronic document providing data for at least one field of a form comprises automatically determining, by a server, a classification for document text of an electronic document; displaying, by a server, a graphical indication of the classification of document text in a first graphical region of a first graphical user interface; responsive to receiving an approval of the classification, generating, by the server, a label for the document text based on the classification; training, by the server, an ML model using the label and the electronic document; executing, by the server, the trained ML model for a second electronic document; for at least one field of a form on a webpage, automatically completing, by the server executing a widget embedded in the web page, the at least one field using the trained ML model; and displaying, by the server, a second graphical indication of text in the second electronic document providing data for the at least one field.

### BRIEF DESCRIPTION OF THE DRAWINGS

FIG. 1 illustrates components of a machine learning (ML) content prediction system, according to an embodiment.

FIG. 2 illustrates a flow diagram of a process executed in the ML content prediction system, according to an embodiment.

FIG. 3 illustrates another flow diagram of a process executed in the ML content prediction system, according to an embodiment.

FIG. 4 illustrates an example document received by the ML content prediction system, according to an embodiment.

FIG. 5 illustrates an example document processed by a character recognition engine, according to an embodiment.

FIG. 6 illustrates example training tasks for the ML model, according to an embodiment.

FIG. 7 illustrates an example transformation layer of the ML model, according to an embodiment.

FIG. 8 illustrates an example output for the training tasks of FIG. 6, according to an embodiment.

FIG. 9 illustrates an example for processing the document for the ML model, according to an embodiment.

FIG. 10 illustrates an example interface with labels marked on an electronic document, according to an embodiment.

FIG. 11 illustrates another example interface with labels marked on an electronic document, according to an embodiment.

FIG. 12 illustrates the example interface of FIG. 10, according to an embodiment.

FIG. 13 illustrates an example widget of a web page, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

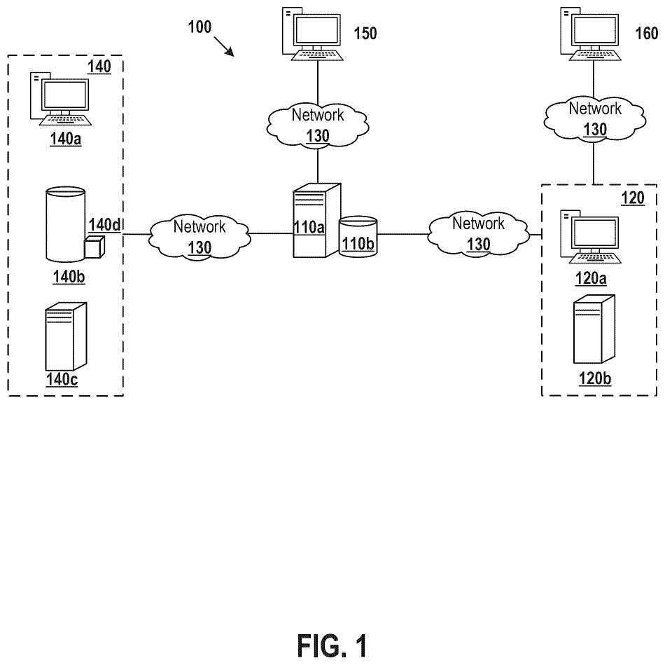

FIG. 1 illustrates components of a machine learning (ML) content prediction system 100. The system 100 may include a server 110a, system database 110b, organization computing devices and organization server's 120a-d (collectively organization computing devices 120), electronic data sources 140a-c (collectively electronic data source 140), an administrator computing device 150, and client computing device 160. The above-mentioned components may be connected to each other through a network 130. The examples of the network 130 may include, but are not limited to, private or public LAN, WLAN, MAN, WAN, and the Internet. The network 130 may include both wired and wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets, or another standard or proprietary wireless communication protocol. In another example, the network 130 may also include communications over a cellular network, including, e.g., a GSM (Global System for Mobile Communications), CDMA (Code Division Multiple Access), EDGE (Enhanced Data for Global Evolution) network.

The system 100 is not confined to the components described herein and may include additional or alternate components, not shown for brevity, which are to be considered within the scope of the embodiments described herein.

The server 110a may generate and display an electronic platform configured to use various models to display predicted results. The electronic platform may include graphical user interface (GUI) displayed on each organization computing device 120 and/or the administrative computing device 150. An example of the electronic platform generated and hosted by the server 110a may be a web-based application or a website configured to be displayed on different electronic devices, such as mobile devices, tablets, personal computer, and the like (e.g., client computing device 160 and/or organization computing devices 120).

As will be describe below, the server 110a may receive an instruction to execute various analytical protocols, such as the ML model, from a user operating the GUI. In some configurations, the server 110a may be programmed, such that it would receive a plurality of documents from the organization servers 120c, the client computing device 160 or the administrator computing device and automatically generate content predictions. In some configurations, the server 110a may be programmed, such that it would generate the prediction based on one or more important text fields within a document. For instance, the server 110a may decide that the name for an individual is important data and the server can execute a protocol to extract the characters of the “name” text field.

The server 110a may execute software applications configured to display the electronic platform (e.g., host a website, an application), which may generate and serve various webpages to each organization computing device 120. Different users operating the organization computing devices 120 may use the website to view and/or interact with the predicted results.

The server 110a may store documents associated with one or more organization computing devices 120. The server 110a may use the documents to train the ML model. For example, the server 110a may use a document, sent by an organization computing device 120 during a previous time period to train the ML model accordingly. The document can contain annotations to train the ML model to extract content from the document. In a non-limiting example, when the predicted results are ignored by a user operating the organization computer 120a, and/or the administrative computer 150, the server may use various back-propagation techniques to train the ML model accordingly.

In some configurations, the server 110a may generate and host webpages based on content extracted from the document within the system 100 (e.g., administrator, employee). In such implementations, the content extracted may be defined by data fields in the document. In some arrangements, the data fields can be defined in the document, or the ML model can make an estimation for data fields in the document. The content can be displayed on the client computing device 160 in order to allow the user to verify that the content extracted is correct.

Organization computing devices 120 may be any computing device comprising a processor and a non-transitory machine-readable storage medium capable of performing the various tasks and processes described herein. Non-limiting examples of a network node may be a workstation computer, laptop computer, tablet computer, and server computer. In operations, various users may organization computing devices 120 to access the GUI operationally managed by the server 110a.

The organization server 120b may be any computing device comprising a processor and non-transitory machine-readable storage capable of executing the various tasks and processes described herein. Non-limiting examples of such computing devices may include workstation computers, laptop computers, server computers, laptop computers, and the like. While the system 100 includes a single organization server 120b, in some configurations, the organization server 120b may include any number of computing devices operating in a distributed computing environment.

The electronic data sources 140 may represent various electronic data sources that contain documents associated with the organization's users or entities. For instance, database 140c and/or server 140b may represent data sources providing the corpus of data (e.g., payment receipts, authorization requests) needed for the server 110a to train one or more ML models. The electronic data sources 140 may also provide metadata associated with the client computing system 160. For example, the electronic data source 140 can provide the server 110a metadata. The metadata can include an IP address, electronic communications information, and/or entity information.

The administrator computing device 150 may represent a computing device operated by a system administrator. The administrator computing device 150 may be configured to display various analytic metrics where the system administrator can monitor the ML training, review feedback, and modify various thresholds/rules described herein. For instance, an administrator can revise precision and/or accuracy metrics generated by the server 110a executing the ML model.

In operation, the server 110a may analyze the data using ML modeling techniques and display the results on the electronic platform. For instance, a user operating the client computing device 160 may log into an application provided by the server 110a where the user can view a likelihood that content from a previous document can be auto filled in a current document. The client computing device 160 may represent a computing device operated by the end user (e.g., client, entity). The client computing device 160 may be configured to display various analytic metrics based on extracted content described herein.

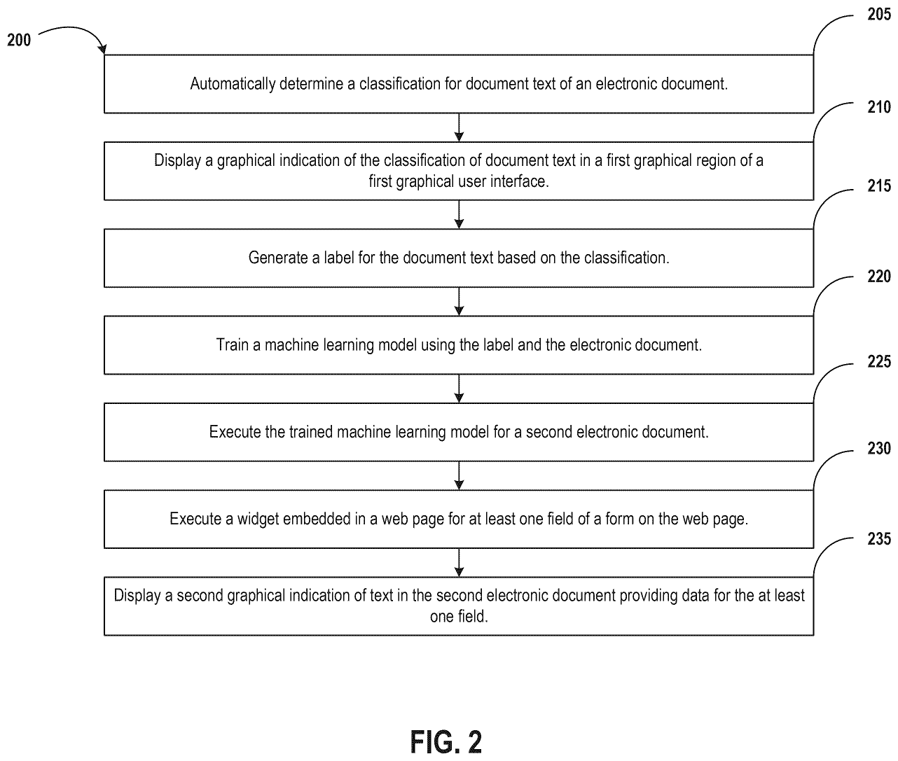

FIG. 2 illustrates a flow diagram of a process executed in the ML content prediction system. The method 200 includes step 205-235. However, other embodiments may include additional or alternative execution steps, or may omit one or more steps (or any part of the steps) altogether. The method 200 is described as being executed by a server (e.g., server 110a). However, one or more steps of method 200 may also be executed by any number of computing devices operating in the distributed computing system described in FIG. 1. For instance, one or more user computing devices may locally perform some or all the steps described in FIG. 2.

Even though some aspects of the embodiments described herein are described within the context of document text extraction, it is expressly understood that methods and systems described herein apply to all AI models and training techniques. For instance, the method 200 may be used to predict text to extract from electronic activities.

At step 205, the server may automatically determine a classification for document text of an electronic document. The electronic document can be transmitted from a computing device (e.g., administrative computing device 150, client computing device 160, organization device 120) and received by the server. The electronic document may be an image (e.g., png, jpeg, jpg), a file (e.g., doc, pdf), or an online form of a document (e.g., sales contract, receipts, government communications, authorization requests). For example, a first user of a first computing device can transmit an image of a bank statement via a network (e.g., network 130), to a second user of a second computing device.

The classification of the electronic document my correspond to a type for the document. The type can define the document as a pay stub, an identification form, authorization request, and a bank statement, among others. In some arrangements, the server can access entity information from the electronic document. The entity information may contain a metadata object corresponding to the entity such as an entity name, entity correspondence (e.g., address, phone number), industry (e.g., agriculture, manufacturing, construction, healthcare). The entity information can be used to determine the classification of the electronic document. For example, an electronic document from Bank of America, can receive a classification of a “financial” document. In another example, electronic document from a law firm, can receive a classification of an “authorization” document.

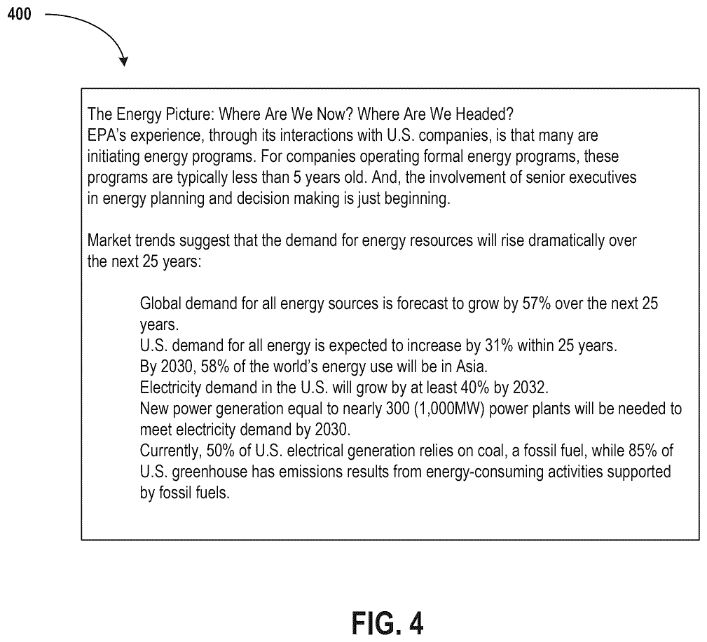

At step 210, the server may display a graphical indication of the classification of document text in a first graphical region of a first graphical user interface. The server may execute a character recognition engine (e.g., Optical Character Recognition (OCR)) to clean the electronic document prior to displaying the graphical indication. FIG. 4 depicts an example document 400 received by the server. The OCR may clean the document 400 by applying a plurality of document improvement techniques. The document improvement techniques may be applied to remove noise and improve clarity of text of the image of the document. For example, the image received by the server may include a blurry document. The OCR may apply noise reduction to reduce blur on the document.

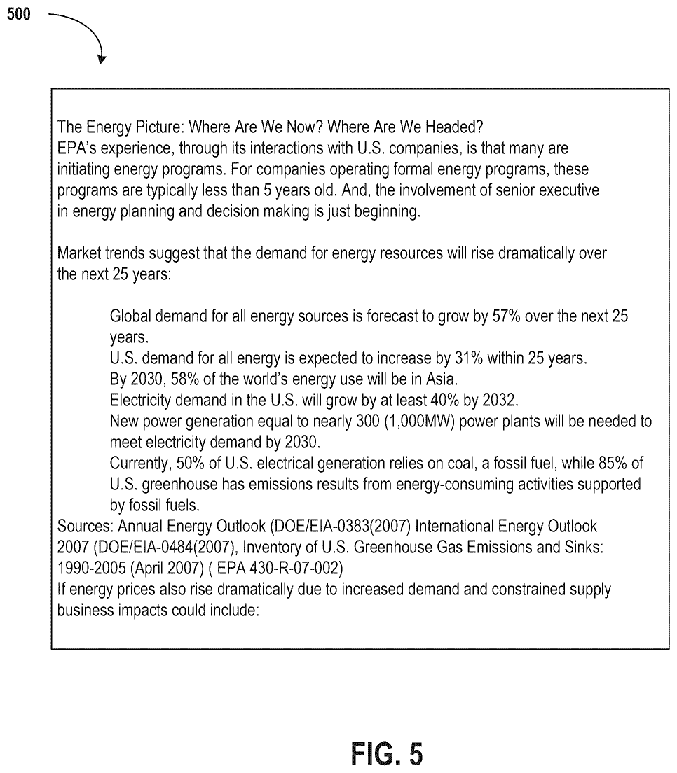

The document improvement techniques may include at least one of line removal, background removal, skew/rotation correction, and clarity adjustments, among others. For example, the server can receive a document which has been rotated by 45 degrees counterclockwise. The OCR may proceed to correct the document by rotating it 45 degrees clockwise. The document improvement techniques may make corrections to names based on the context of the document. For example, a document may state “I, John Dor, hereby authorize the transaction in the amount of $50,000.” The document may later state, “I, John Doe, hereby am the person of record for this document.” In this example, the improvement technique will recognize the incorrect spelling of “John Dor” to “John Doe” based on the previous occurrence of John Doe. In some arrangements, the OCR may adjust the background color to improve clarity. In some arrangements, the OCR may trim the excessive bounds of the image. FIG. 5 depicts an example document 500 processed by the OCR. The processed document 500 is the result of applying the document improvement techniques on the document 400.

The graphical indication may include a visual identifier for the classification. The visual identifier can include a colored box (e.g., red box, blue box), a highlighted region, an underlined region, or a circled region. The computing device can include hardware components and software to execute the first graphical interface. The geographical indication in the first graphical user interface can be configured to interact with a user of the computing device. The user can approve the geographical indication or deny the indication. Denying the geographical indication determines that the classification is not correct for the document text. Approving the geographical indication determines that the classification is correct for the document text. For example, the classification of document text can be determined to be “bank statement,” but a user can identify the document text as a “transaction agreement,” thus denying the geographical indication.

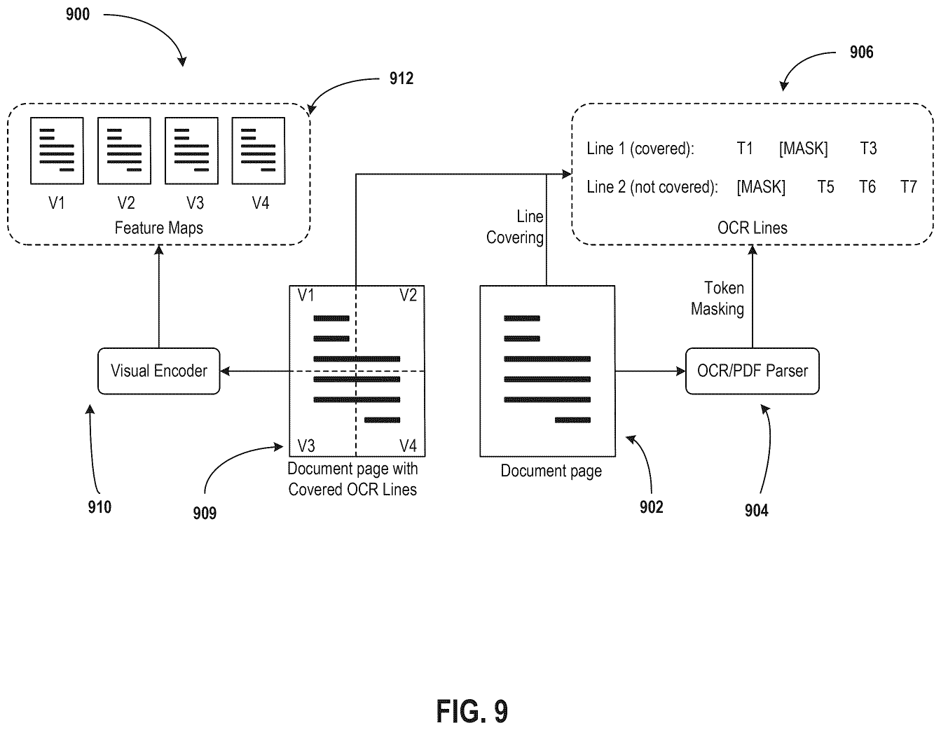

FIG. 9 illustrates an example diagram 900 for processing the document for the ML model. The server 110a can include the document page 902, an OCF/PDF parser 904, OCR lines 906, document page with covered OCR lines 909, a visual encoder 910, and feature maps 612. The above components may be interconnected via the sever 110a. The server 110a may include hardware and machine-readable instructions to execute the above components. An order in which the server 110a executes the above components may not be defined. For example, the server 110a can receive a document page 902. The server 110a may proceed to mask OCR lines 906 without sending the document through the OCR/PDF Parser 904. In some arrangements, the server 110a may receive the document page 902. The server 110a may proceed to send the document page 902 to the OCR/PDF Parser 904.

The document page 902 may be a page in the document 200. In some arrangements, the document 200 may include one or more document pages 902. For example, the document 200 can include one-hundred document pages 902. The document page 902 may include a plurality of text. The ML model can decipher the content to extract from the text. The server 110a may receive one or more documents 200, each document 200 with a plurality of pages. The server may use the OCR on each document page 902 corresponding to each of the documents 200.

The OCR/PDF parser 904 may extract content, data, and metadata of the document page 902. The OCR/PDR parser 904 may analyze the structure of the document 902 to mark the document page 902 with map markers to process the document page 902. For example, the OCR/PDF parser 904 can mark the document page 902 with four sections to generate mappings for each section. In some arrangements, the OCR/PDF parser can extract font information to store a correlation between the font and the entity. In some arrangements, the OCR/PDF parser 904 may include token masking.

The server 110a may use the OCR lines 906 to determine or recognize lines in the document page 902. The OCR lines 906 may include a MASK token on text within a line of the document page 902 to train the ML model to guess a word, phrase, letter, or name within the line. For example, a line in the document page 902 can state “All of these as received in writing, authorized by John Doe,” and the OCR lines 906 can state “All of these as [MASK] in writing, authorized by John Doe.” In another example, the document page 902 can state “In light of the agreement by the parties, each party has a duty to disclose any findings of prior art” and the OCR lines 906 can state, “In light of the [MASK] by the parties, each party has a duty to disclose any findings of prior art.” In yet another example, the document page 902 can state “Jane Smith is entitled to 24/7 custody of her children as Joe Smith has been deemed an incompetent parent, and the OCR lines 906 can state “Jane Smith is entitled to [MASK] custody of her children as Joe Smith has been deemed an incompetent parent.” In some arrangements, the OCR lines 906 can mask an entire line in the document page 902. In some arrangements, the OCR lines 906 can mask an entire line in the document page 902.

The server 110a can use the document page with covered OCR lines 908 to prepare the inputs (e.g., electronic documents) to the ML model to help the ML model understand the context of the document page 902. The document page 902 can be covered with OCR lines to establish different portions of the document page 902 to be processed. The portions of the document page 902 are sent into the visual encoder 910. The visual encoder 910 may transform the document page covered with OCR lines 908 into a numerical or feature representation. In some arrangements, the visual encoder may extract the portions of the document page with OCR lines 908 to generate a plurality of feature maps 912.

At step 215, the server may generate a label for the document text based on the classification, in response to receiving an approval of the classification. The approval of the classification may be received by the server from the computing device of the user. The approval may be stored in a database (e.g., database 110b). The approval may be used for a future electronic document which may be similar to a previous electronic document. For example, a first transaction report received in October 2022 may receive a classification by the server and the user can approve the classification. The server will generate a label for the first transaction report. A second transaction report received in October 2023, may receive the generated label from October 2022. The label can be attached to the electronic document and can be displayed on a second geographical user interface. In some instances, the server can receive a rejection of the classification.

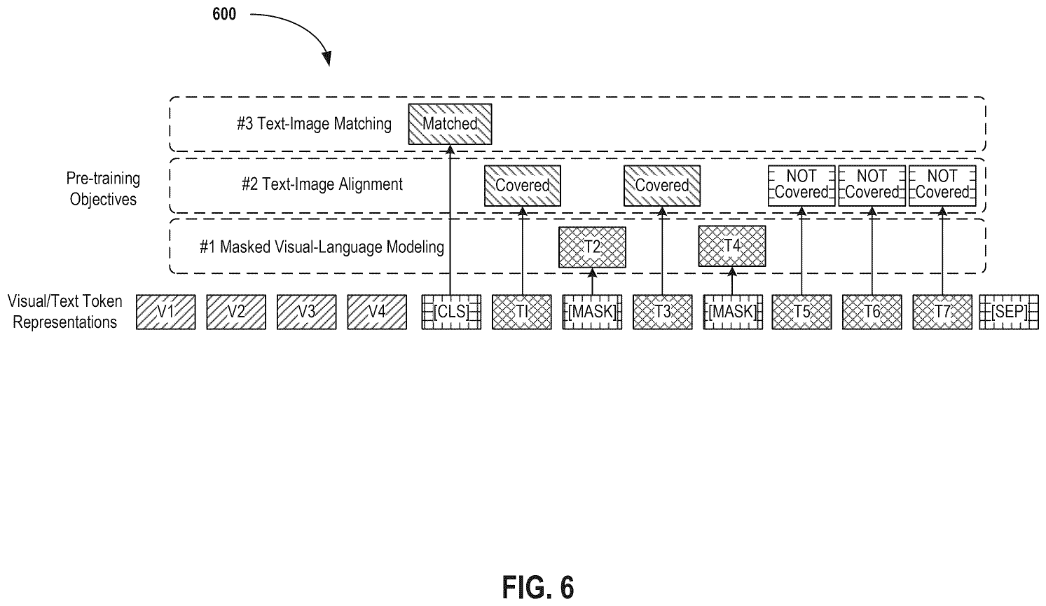

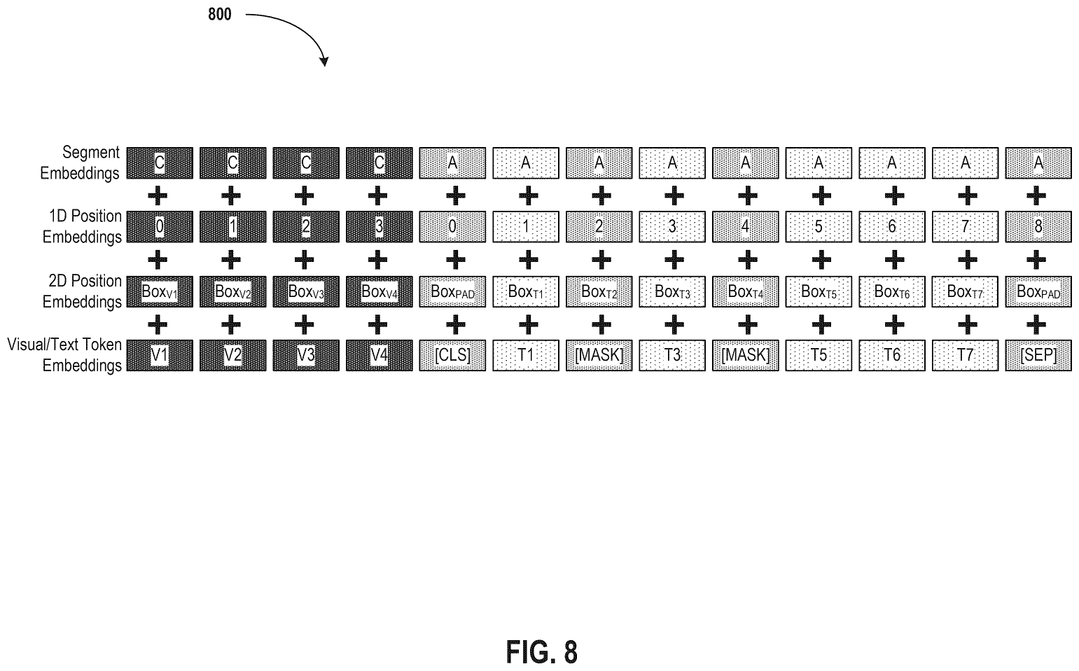

At step, 220, the server may train a ML model using the label and the electronic document. The ML model may execute a plurality of training tasks to train the ML model within a training dataset. The training data set can include the plurality of training tasks, a plurality of annotated documents, and correct classifications for the annotated documents. FIG. 6 and FIG. 8 illustrate example training tasks for a ML model, of the server and the output of the ML model. The training tasks 600 can include text-image matching. For example, the ML model may receive an image with text and extract each character in the text of the image. The training tasks may include text-image alignment. For example, the ML model may align the text to extract the necessary content. The training tasks may include visual-language modeling (e.g., Bidirectional Encoder Representations from Transformers). Certain words in a sentence may be randomly replaced with a Visual/Text token (e.g., MASK) to train the model to predict the token based on the context of the surrounding words.

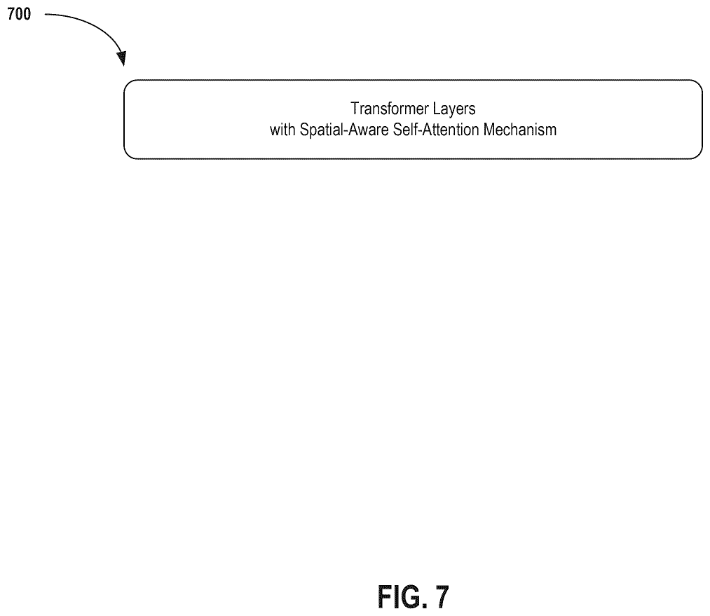

The ML model may include one or more transformer layers. FIG. 7 illustrates an example transformation layer 700 (referred to as a multi-modal Transformer architecture herein) of the ML model. The ML model may include a multi-modal Transformer architecture (MMTA) 700. The MMTA 700 may take text, visual, and layout information as an input to establish deep cross-modal interactions. The MMTA 700 may include a spatial-aware self-attention mechanism to the MMTA 700 for better modeling a document layout. The MMTA 700 can include text embedding, visual embedding, and layout embedding. For example, text embedding can include tokenizing an OCR sequence and assigning each token to a certain segment. In another example, visual embedding can include converting a document image to a fixed-length sequence and further updating parameters through backpropagation. In yet another example, layout embedding may include normalizing and discretizing all coordinates to integers in the range [0,1000], and using two embedding layers to embed x-axis features and y-axis features separately. The spatial-aware self-attention mechanism can relate different positions of a single sequence and create a representation of the same sequence. In some arrangements, the transformer layer can decode different segments of the processed text by the OCR. For example, a segment may include the phrase “I hereby authorize James to handle all correspondence with Company A,” and the transformation layer can reorder “James” and Company A” to establish different sequences of the input.

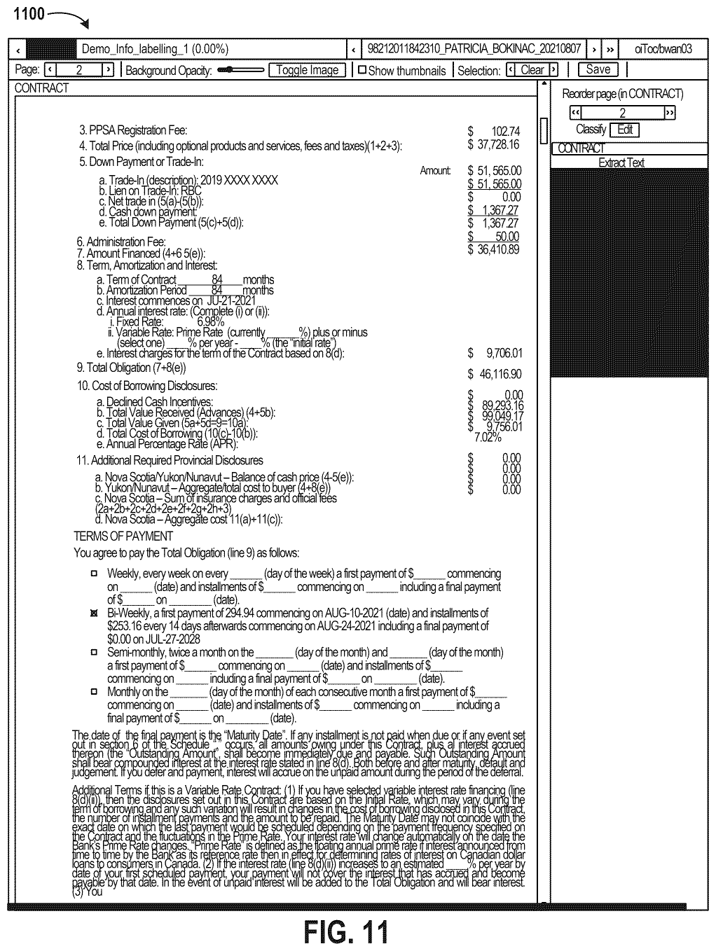

The ML model may use the label to learn the geographical indication of the classification. For example, The ML model may use the label to determine that a total fee will be located under one or more values separated by a line. FIG. 11 illustrates an example interface 1100 with labels on the electronic document. The ML model may detect highlighted portions of the electronic document and make an association between the highlighted portions and the type of document. The ML model may determine to observe a geographical location near the top right of the electronic document 1100 to find the financial value to classify.

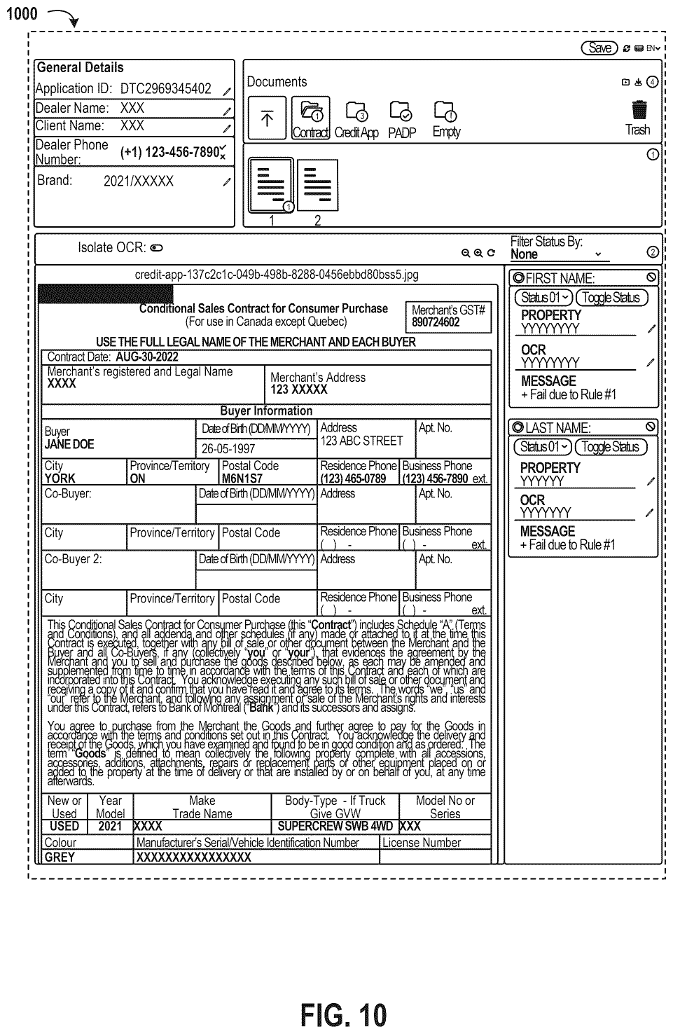

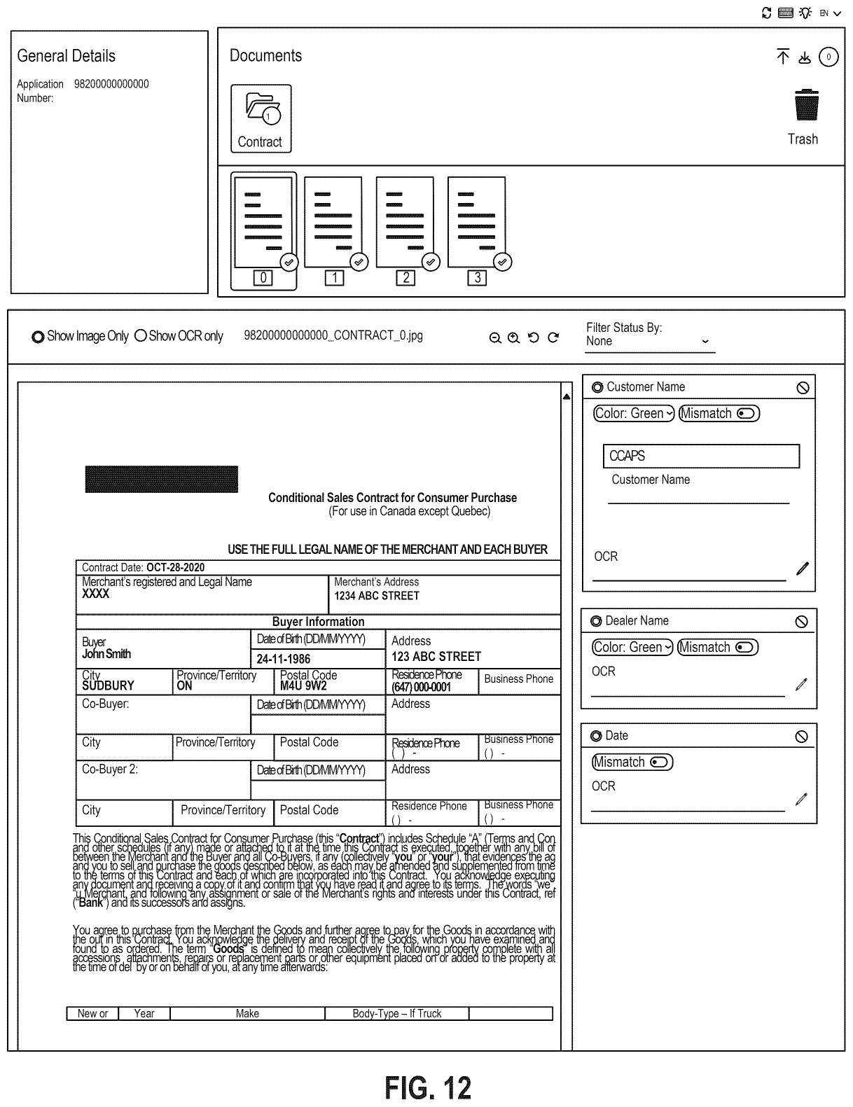

FIG. 10 illustrates another example interface 1000 with labels on the electronic document. The electronic document can include section headings for different sections of the electronic document. The electronic document of interface 1000, includes a plurality of headings and the ML model can make associations between the labels and the headings of the electronic document. The ML model use the associations for certain document types to further identify the geographic locations for the classifications. FIG. 12 illustrates another example interface 1200 with labels on the electronic document. The interface 1200 may include the same associations as interface 1000.

At step 225, the server may execute the ML model to predict a classification for a second electronic document. The predicted classification of the electronic document my correspond to a predicted type for the document. The predicted type can define the document as a pay stub, an identification form, authorization request, and a bank statement, among others. In some arrangements, the server can access entity information from the electronic document. The entity information may contain a metadata object corresponding to the entity such as an entity name (e.g., Bank of America, Apple, Lockheed Martin), entity correspondence (e.g., address, phone number), industry (e.g., agriculture, manufacturing, construction, healthcare). The entity information can be used to determine the classification of the electronic document. For example, an electronic document from Bank of America, can receive a predicted classification of a “financial” document. In another example, electronic document from a law firm, can receive a predicted classification of an “authorization” document.

In some arrangements, the predicted classification may be corrected by the extracted content from the OCR. For example, the classification may indicate that the document is a financial document, but the OCR may extract a government stamp. Thus, the ML model may correct the predicted classification to be a government document. In some arrangements, the extracted content may be corrected by the predicted classification. For example, the OCR may extract values (e.g., corresponding to a financial institution), but the predicted classification may suggest the document is an employee report with each employee's salary listed along with their respective name and address. Thus, the ML model may send a request to the server to extract context from the document again.

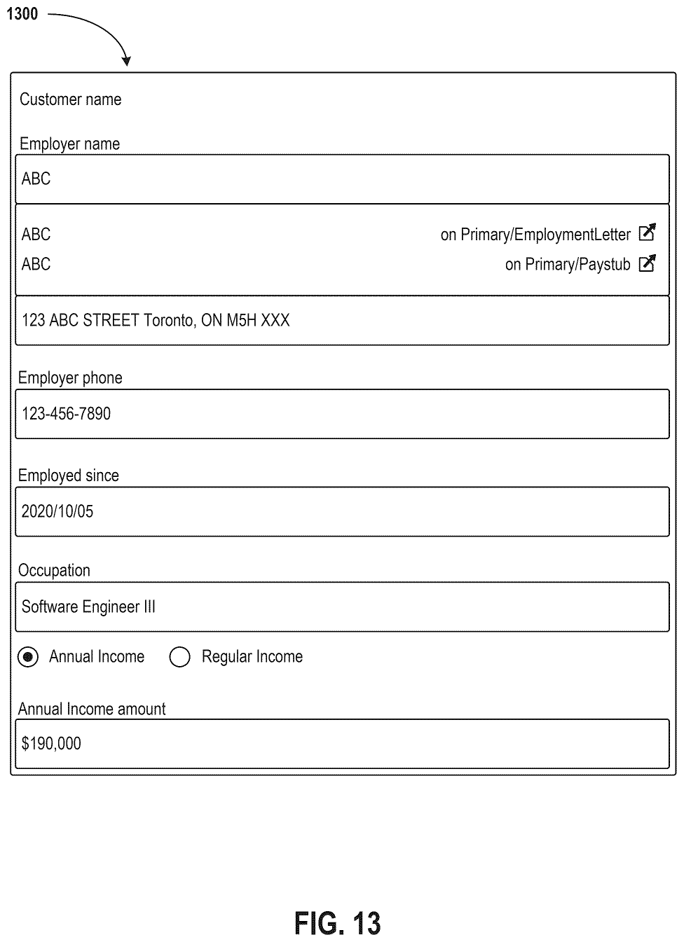

At step 230, the server may execute a widget embedded in a web page for at least one field of a form on the web page. The at least one field uses the trained ML model. FIG. 13 illustrates an example widget 1300 of a web page. The at least one field can be filled by the document text within the predicted classification from the trained ML model. In some arrangements, the ML model can provide multiple classifications for the at least one field in the form. For example, a field on a form can include an employer name and the ML model can identify one or more classifications for the employer's name. In this example, the employer's name can be “ContextLogic Technologies, Inc. dba Wish” or “CONTEXTLOGIC TECHNOLOGIES INC.” In another example, a field on a form can include a phone number and the ML model can identify one or more classifications for the phone number. In this example, the phone number can be “123-456-7890” or “987-654-3210.”

At step 235, the server may display a second graphical indication of text in the second electronic document providing data for the at least one field on a second graphical interface. In some arrangements, the second graphical indication can correspond to the function of the first graphical indication. A user of the computing system may view the data for the at least one field on the second graphical interface. Upon review of the data for the at least one field on the second graphical user interface, the server can generate feedback data for the ML model. The feedback data can include feedback (e.g., corrections, approvals, or rejections) based on the predicted classification and the data for the at least one field. The server can apply the feedback to the ML model to update one or more weights of the ML model. By updating the one or more weights, the ML model can further improve classifications of the data within the at least one fields. The server can use the feedback data to calculate a loss metric to update the one or more weights.

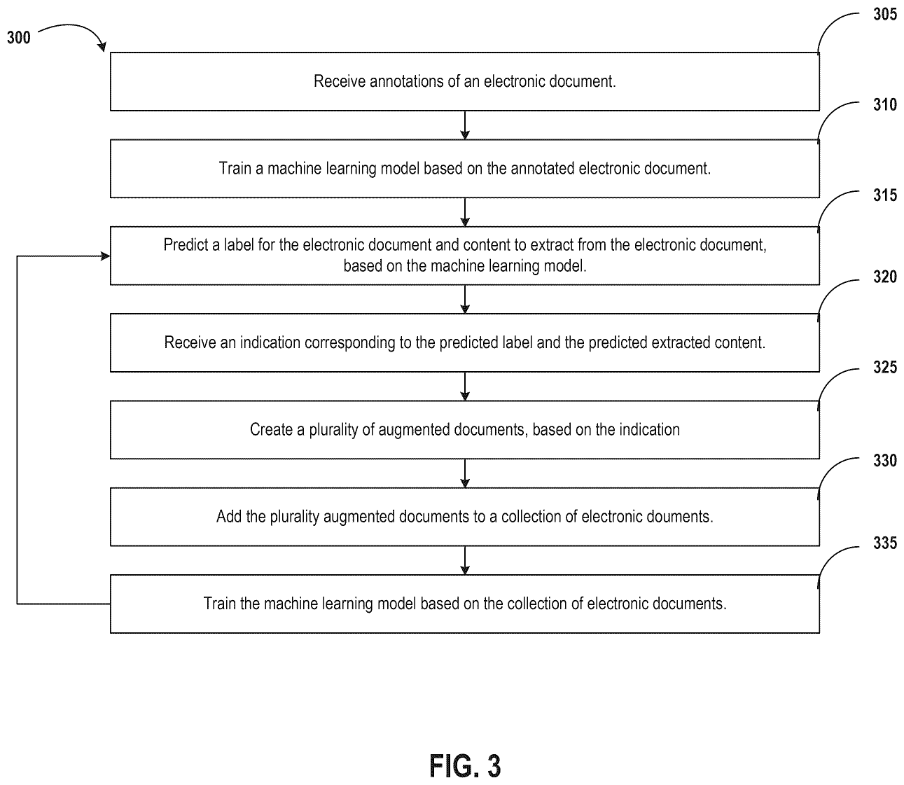

FIG. 3 illustrates another flow diagram of a process executed in the ML content prediction system. The method 300 includes step 305-335. However, other embodiments may include additional or alternative execution steps, or may omit one or more steps (or any part of the steps) altogether. The method 300 is described as being executed by a server, similar to the server described in FIG. 1. However, one or more steps of method 300 may also be executed by any number of computing devices operating in the distributed computing system described in FIG. 1. For instance, one or more user computing devices may locally perform part or all the steps described in FIG. 3.

At step 305, a server may receive annotations of an electronic document from a computing device (e.g., administrator computing device 160, client computing device 150). The annotations can include boxes around content to be extracted, strikeouts of irrelevant content, and/or highlights to indicate content to be extracted. The annotations can be made on non-annotated documents or annotated documents to improve content detection of a ML model.

At step 310, the server may train a ML model based on the annotated electronic document. The ML model may use the annotated electronic documents to pretrain the ML model and tune the model to determine a classification for the annotated electronic document. The ML model may detect any annotations to the document to learn the classification to form labels for the electronic document. In some arrangements, the ML model may store the classification based on the entity. For example, the ML model may store signatures for an authorization document by a corporation but may choose to not store signatures from a bank statement without a signature.

In some arrangements, the ML model may be rule based depending on the requirements established by the computing device. Therefore, the ML model may include one or more rules for training on documents and content to extract. For example, a rule may state that the ML model cannot predict to extract any values comprises of XXX-XX-XXXX format as this may associate with a social security number. In another example, a rule may state that the ML model cannot train on any documents labeled as confidential or secret.

In some arrangements, the ML model may be dynamically created from a plurality of configuration (.config) files. The server may generate new models based on each of the .config files to experiment on ML models which may be optimal for classification prediction and content extraction. For example, the server may use a first .config file to create a first ML model to be used for document classification, whereas the server may use a second .config file to create a second ML model for content extraction. By generating new ML models, the server can apply a respective ML model to a specific electronic document. For example, the server can generate a first ML model for a bank statement, a second ML model for a check, a third ML model for a utility bill and so on.

In some arrangements, the server may automatically select a base model for the ML model for training based on the classification and the label of the document. For example, the server may select a base model and tune the parameters for the ML model. The server may adjust the parameters of the ML model improve the training of the ML model. The server may adjust the parameters using at least one of Bayesian Optimization, Gradient Descent, Stochastic Average Gradient, Root Mean Square Propagation, or Particle Swarm Optimization, among others. For example, during training, the server may use Bayesian Optimization to improve the performance of the ML model.

At step, 315, the ML model may predict a label and content to extract from the electronic document, based on the ML model and the classification of the electronic document. The classification of the electronic document may correspond to a label for the document. The classification may be based on the content of the annotated documents. For example, a document which contains a plurality of numbers and dollar signs may correspond to a financial document. In some arrangements, the content to extract may be based on the classification of the document. For example, the title of a document may indicate that the document is a financial document. Thus, the ML model may extract numerical values with dollar signs as appropriate.

The predicted content may include content extracted from the annotated documents determined by the predicted label. In some arrangements, the model can recognize the label of the document text and extract content corresponding to the label. The predicted content can include strings (e.g., text, ASCII, lexicon), numeric values (e.g., phone numbers, monetary values), and special characters. The predicated content may be stored in a database (e.g., database 110b) to store an association between the predicted label and the predicted content corresponding to the entity for the document. The server may transmit the predicted label and predicted extracted content to a user of the computing device, via a geographical interface.

Upon generation of the new ML models, the server can use the predicted label and content to determine the ML model. To determine the ML model, the server can select at least one ML model from the generated plurality of ML models according to the predicted label and content. For example, the server can determine that the annotated document is a bank statement based on the predicted label and content, therefore the server can select a first ML model for use.

At step 320, the server, from the user of the geographical interface, may receive an indication corresponding to the predicted label and predicted extracted content (referred to as predicted output herein). The indication can be a correct indication or an incorrect indication, corresponding to a loss metric. The loss metric can quantify the predicted output and the correct output (defined by the user). A low loss metric can correspond to the correct indication whereas, a high loss metric can correspond to the incorrect indication. The loss metric can allow the ML model to adjust parameters or weights to minimize the discrepancy between the predicted output and the correct output. The loss metric calculated by Mean Squared Error, Cross-Entropy loss, or Mean Absolute Error among others.

At step 325, the server may create a plurality of augmented documents based on the indication. The server may replace the text of the electronic documents with random strings, similar to an original electronic document. For example, the annotated document may have a box around “first name: John Doe.” The server may replace “John Doe” with “Josh Smith.” The server may create a new document based on the replacement of the text strings. The replaced text may be stored in the database to increase the plurality of documents and train the model. The server may add noise to the plurality of augmented documents to simulate conditions of the electronic document from the entity.

At step 330, the server may add the plurality of augmented documents a collection of electronic documents. The addition of the plurality of augmented documents increases the collection of electronic documents and provide the ML model with a larger training pool. The sever can obtain a larger training set without increasing overhead and train the ML model with minimal resources. By utilizing a larger training pool, the server can further train and update the base ML model while generating a plurality of ML models for the annotated document. In this manner, the systems and methods described herein can generate a plurality of ML models to commensurate a plurality of annotated documents.

At step 335, the server may train the ML model based on the collection of electronics documents. The collection of electronic documents may include, annotated electronic documents, the augmented documents, the non-annotated electronic documents, and extracted content from the documents. The ML model is trained on a larger training set to fine-tune the model and improve prediction classifications and predicted content to extract from the documents. The method 300 may proceed to step 315 to repeat steps 315-335. The method 300 is continuous and improves the performance of the ML model.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
automatically determining, by a server, a classification for document text of an electronic document;
displaying, by the server, a graphical indication of the classification of document text in a first graphical region of a first graphical user interface;
responsive to receiving an approval of the classification, generating, by the server, a label for the document text based on the classification;
training, by the server, a machine learning (ML) model using the label and the electronic document;
executing, by the server, the trained ML model for a second electronic document;
for at least one field of a form on a webpage, automatically completing, by the server executing a widget embedded in the web page, the at least one field using the trained ML model; and
displaying, by the server, a second graphical indication of text in the second electronic document providing data for the at least one field.

2. The method of claim 1, further comprises:
extracting, by the server, content of the label for the document text;
training, by the server, the ML model using the content of the label;
executing, by the server, the trained machine leaning model for the second electronic document;
for at least one field of a form on a web page, generating a list of widgets embedded in the web page, the at least one field using the trained ML model; and
displaying, by the server, the list of widgets corresponding to the at least one field of the form, the list of widgets comprising predicted content from the trained ML model and a confidence score, wherein the predicted content is ordered based on the confidence score.

3. The method of claim 1, further comprises:
receiving, by the server, feedback associated with the at least one field, the feedback indicating at least one of an approval of the at least one field or a rejection of the of at least one field; and
updating, by the server, one or more weights of the ML model based on the feedback.

4. The method of claim 1, further comprises:
generating, by the server, a plurality of ML models according to the classification and the label for a plurality of documents, each of the plurality of ML models generated for a respective document in the plurality of documents; and
selecting, by the server, a first ML model for a second document similar to the document.

5. The method of claim 1, wherein training the ML model further comprises training, by the server, the ML model by applying a training data set including a plurality of tasks, a plurality of annotated documents, and a plurality of fields each annotated document.

6. The method of claim 1, further comprises receiving, by the server, a response from the computing device indicating an approval of the classification.

7. The method of claim 1, wherein the ML model is a base model, wherein training the ML model further comprises automatically selecting the base model according to the classification and the label for the document.

8. The method of claim 1, further comprises executing, by the server, a character recognition engine on the electronic document to remove noise associated with the document text.

9. The method of claim 1, further comprises receiving, by the server, an image of the electronic document from the computing device.

10. The method of claim 1, wherein the graphical indication includes at least one of a colored box, a highlighted region, an underlined region, or a circled region on the electronic document.

11. A system comprising a server including one or more processors to:
automatically determine a classification for document text of an electronic document;
display a graphical indication of the classification of document text in a first graphical region of a first graphical user interface;
responsive to receiving an approval of the classification, generate a label for the document text based on the classification;
train a machine learning (ML) model using the label and the electronic document;
execute the trained ML model for a second electronic document;
for at least one field of a form on a webpage, automatically complete, by executing a widget embedded in the web page, the at least one field using the trained ML model; and
display a second graphical indication of text in the second electronic document providing data for the at least one field.

12. The system of claim 11, the server configured to:
extract content of the label for the document text;
train the ML model using the content of the label;
execute the trained machine leaning model for the second electronic document;
for at least one field of a form on a web page, generate a list of widgets embedded in the web page, the at least one field using the trained ML model; and
display the list of widgets corresponding to the at least one field of the form, the list of widgets comprising predicted content from the trained ML model and a confidence score,
wherein the predicted content is ordered based on the confidence score.

13. The system of claim 11, the server configured to:
receive feedback associated with the at least one field, the feedback indicating at least one of an approval of the at least one field or a rejection of the of at least one field; and
update one or more weights of the ML model based on the feedback.

14. The system of claim 11, the server configured to:
generate a plurality of ML models according to the classification and the label for a plurality of documents, each of the plurality of ML models generated for a respective document in the plurality of documents; and
select a first ML model for a second document similar to the document.

15. The system of claim 11, wherein, when training the ML model, the server configured to train the ML model by applying a training data set including a plurality of tasks, a plurality of annotated documents, and a plurality of fields each annotated document.

16. The system of claim 11, the server configured to receive a response from the computing device indicating an approval of the classification.

17. The system of claim 11, wherein the ML model is a base model, wherein, when training the ML model, the server configured to automatically select the base model according to the classification and the label for the document.

18. The system of claim 11, the server configured to execute a character recognition engine on the electronic document to remove noise associated with the document text.

19. The system of claim 11, the server configured to receive an image of the electronic document from the computing device.

20. The system of claim 11, wherein the graphical indication includes at least one of a colored box, a highlighted region, an underlined region, or a circled region on the electronic document.
